(19) United States
(12) Patent Application Publication
(10) Pub. No.: US 2010/0075539 A1
(43) Pub. Date: Mar. 25, 2010

(54) ELECTRICAL CONNECTOR AND THE TERMINAL THEREOF

(75) Inventor: Jui-Cheng CHANG, Taichung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: MERRY ELECTRONICS CO., LTD., Taichung (TW)

(21) Appl. No.: 12/237,700

(22) Filed: Sep. 25, 2008

(51) Int. Cl. H01R 25/00

(52) U.S. Cl. 439/638

(57) ABSTRACT

An electrical connector is disclosed, which is configured with an insulating frame for carrying a speaker while arranging terminals at two sides of the insulating frame. Each of the terminals further comprises a vertical-extending fixing part for holding securely on the insulating frame, and a movable part connected to the fixing part while parallel-extending from the same. With the aforesaid structure, as the terminals only occupy a small space available on the insulating frame comparing with those conventional connectors, the electrical connector of the invention is able to carry a speaker with larger magnet so that the aforesaid electrical connector is preferred as it can, in a way, enhance the electrical performance of the speaker.

### FIELD OF THE INVENTION

The present invention relates to an electrical connector, and more particularly, to an electrical connector adapted for connecting to an electric-acoustic product.

### BACKGROUND OF THE INVENTION

Despite there are all kinds of consumer electronic products currently available on the market, any of they can only distinct itself from the others by the sounds and images that it can provide to the consumers. As most audio effects are achieved through speakers, it is common to install speakers on today's consumer electronic products, such as cellular phones or earpieces, to be used as audio output devices.

Please refer to FIG. 1, which shows a conventional electrical connector for speakers. In FIG. 1, the electrical connector 1 is composed of an insulating frame 100 and two terminals 101, in which the insulating frame 100 is designed with a center area to be used for carrying a speaker. In addition, each terminal 101, made of a conductive metal, is configured with a fixing end and a free end, in which the fixing end is embedded inside the insulating frame 100 when the frame 100 is formed by injection molding so that the fixing end is integrally formed with the insulating frame 100 and can be used for electrically connecting the terminal 101 with the speaker. In addition, as the fixing end of the terminal 101 is fixedly embedded in the insulating frame 100, the free end which is substantially a curved extension of the fixing end is able to be bended elastically relative to the insulating frame 100. By the use of the terminals 101, the electrical connector can be connected electrically with the substrate of an electric device.

However, the aforesaid conventional electrical connector 1 is not perfect as its design requires that the terminal 101 must maintain a specific width D1 at the position contacting to the insulating frame 100, i.e. the width D1 of the fixing end of each terminal 101. Consequently, the terminals 101 will occupy a relative larger space available on the insulating frame 100 so that the volume of the speaker capable of being carried by the insulating frame 100 is restricted since the space left for carrying the speaker is restricted. Since the volume of the speaker is restricted, the size of the magnet used in such speaker is also restricted so that, in some way, the electrical performance of the speaker is adversely affected by the overall structural design of the aforesaid electrical connector.

Moreover, as at the final step for fabricating the aforesaid electrical connector 1 that the free end of each terminal 101 is deflected and thus bended so as to complete the whole structure of the connector 1, the production yield of the electrical connector 1 will be adversely affected by the deflecting step and therefore the manufacturing cost is increased. Also, as each terminal 101 of the electrical connector 1 is designed to extend inwardly away from the outer edge of the insulating frame 100, the tip 102 of the free end of each terminal 101 is located at a position away from the outer edge of the insulating frame 100 that may cause the electrical connector 1 to be adapted for connecting with a certain substrates and thus usefulness of the electrical connector 1 is restricted. In addition, when the electrical connector 1 is inset in an electronic product, the free end of each terminal 100 will be subject to a pressing force and thus deflect in relative to its fixing end for a long period of time and during which the substrate of the electronic product will be subjected to an reacting force in relation to such pressing force exerting on the terminal 101. Consequently, the connection between the electrical connector and the electronic product will be damaged by either the substrate is damaged by the reacting force, or the elastic fatigue of the terminal 101 after being subjected to the pressing force for a long time.

Please refer to FIG. 3, which shows another conventional electrical connector. In FIG. 3, the electrical connector 2 is composed of an insulating frame 200 and two terminals 201, in which the insulating frame 200 is designed with a center area to be used for carrying a speaker. In addition, each terminal 201, made of a conductive metal that is curved by the use of a mechanical means before it is assembled with the insulating frame 200, is processed by a specific machinery to be fixed to a side of the insulating frame 200 for enabling the same to connect electrically to the speaker and also to be capable of connecting electrically with the substrate of an electronic product when the electrical connector is inset into the same. Thus, there are plenty of rooms for improvement in the aforesaid electrical connector 2.

As shown in FIG. 4, the aforesaid conventional electrical connector 2 is suffering by the same disadvantage as the one described in FIG. 2 that the terminal 201 of the connector 2 must maintain a specific width D2 at the position contacting to the insulating frame 200 i.e. the width D1 of the fixing end of each terminal 101. Consequently, the terminals 201 will occupy a relative larger space available on the insulating frame 200 so that the volume of the speaker capable of being carried by the insulating frame 200 is restricted since the space left for carrying the speaker is restricted. Since the volume of the speaker is restricted, the size of the magnet used in such speaker is also restricted so that, in some way, the electrical performance of the speaker is adversely affected by the overall structural design of the aforesaid electrical connector.

Moreover, as the terminal 201 requires to be processed by the specific machinery so as to be attached to the insulating frame 200, the use of such specific machinery may cause the manufacturing cost of the electrical connector 2 to increase. In addition, similar to the one described in FIG. 1, as each terminal 201 of the electrical connector 2 is designed to extend inwardly away from the outer edge of the insulating frame 200, the tip 202 of the free end of each terminal 201 is located at a position away from the outer edge of the insulating frame 200 that may cause the electrical connector 2 to be adapted for connecting with a certain substrates and thus usefulness of the electrical connector 2 is restricted. Also, as the free end of each terminal 201 is also the extension of its fixing end, it suffers the same disadvantages as the one described in FIG. 1 that the connection between the electrical connector 2 and the electronic product will be damaged by either the substrate is damaged by the reacting force, or the elastic fatigue of the terminal 201 after being subjected to the pressing force for a long time. Thus, there are plenty of rooms for improvement in the aforesaid electrical connector 2.

### SUMMARY OF THE INVENTION

In view of the disadvantages of prior art, the primary object of the present invention is to provide a low-cost, easy-to-manufacture electrical connector.

To achieve the above object, an electrical connector is disclosed which is configured with an insulating frame for carrying a speaker while arranging terminals at two sides of the insulating frame. In a preferred embodiment, each of the terminals includes a vertical-extending fixing part for holding securely on the insulating frame, and an elastic movable part connected to the fixing part while parallel-extending from the same. With the aforesaid structure, as the terminals only occupy a small space available on the insulating frame comparing with those conventional connectors, the electrical connector of the invention is able to carry a speaker with larger magnet so that the aforesaid electrical connector is preferred as it can, in a way, enhance the electrical performance of the speaker. In addition, not only the damages caused by the elastic fatigue and reacting force as those conventional electrical connectors can be prevented, but also as the terminal can be formed by a stamp molding process with being processed by the specific machinery as those used in the fabrication of conventional electrical connectors, its manufacturing cost can be reduced while preserving a yield that is also high than those conventional electrical connectors.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional electrical connector.

FIG. 2 is a top view of FIG. 1.

FIG. 3 shows another conventional electrical connector.

FIG. 4 is a top view of FIG. 3.

FIG. 5 shows an electrical connector according to a preferred embodiment of the invention.

FIG. 6 is an exploded view of the electrical connector depicted in FIG. 5.

FIG. 7 is a top view of an insulating frame of the electrical connector depicted in FIG. 5.

FIG. 8 is a top view of a terminal of the electrical connector depicted in FIG. 5.

FIG. 9 is a top view of the electrical connector depicted in FIG. 5.

FIG. 10 is a cross sectional view of the electrical connector depicted in FIG. 5.

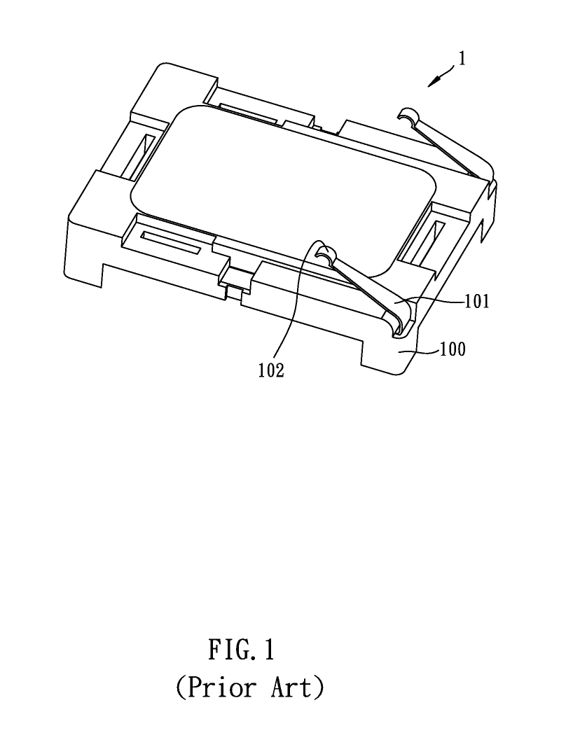

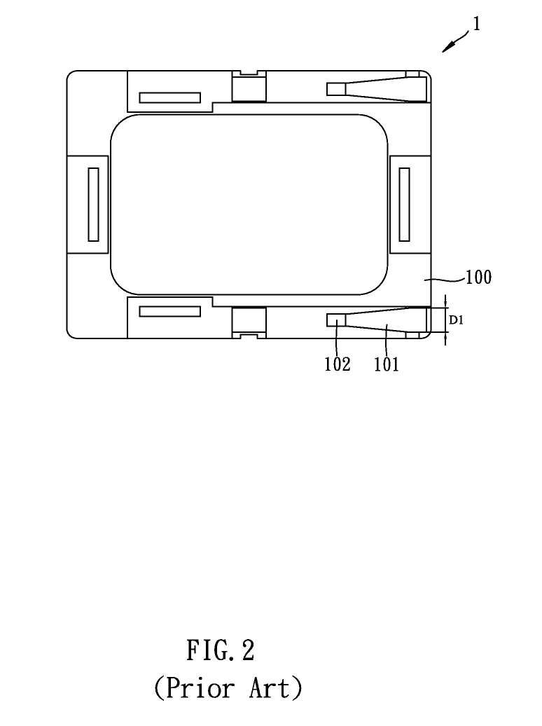

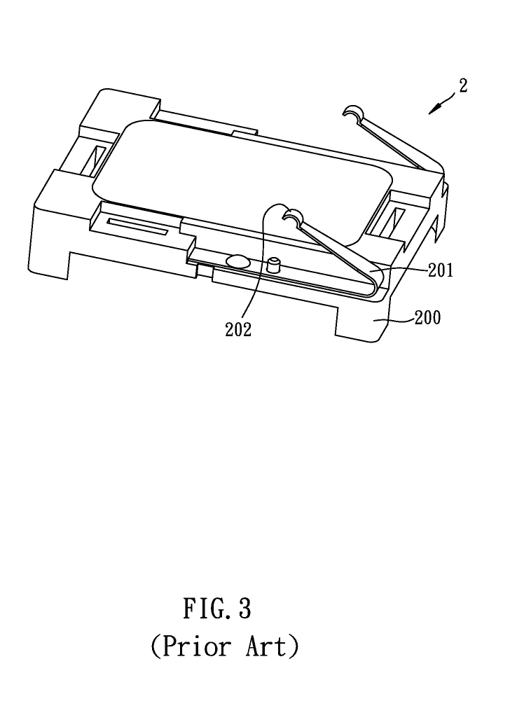

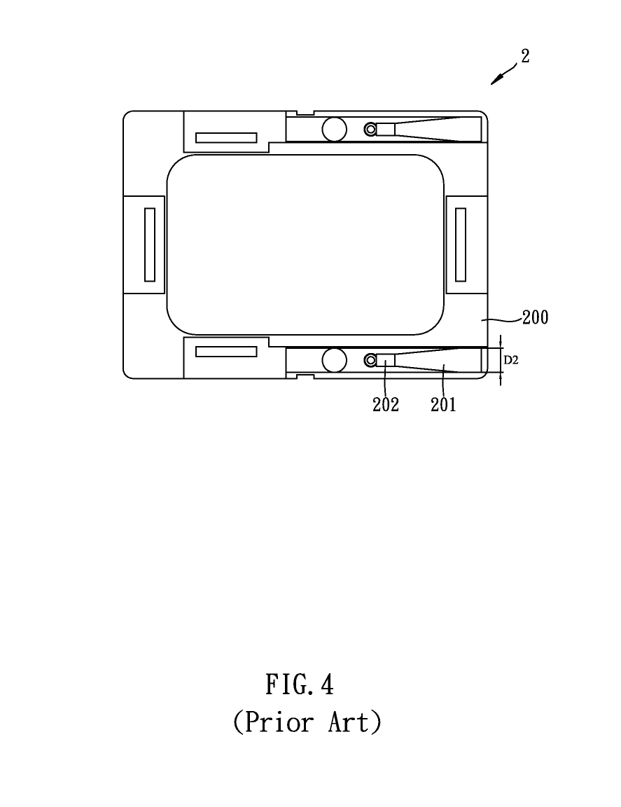

### DETAILED DESCRIPTION

For your esteemed members of reviewing committee to further understand and recognize the fulfilled functions and structural characteristics of the invention, several exemplary embodiments cooperating with detailed description are presented as the follows.

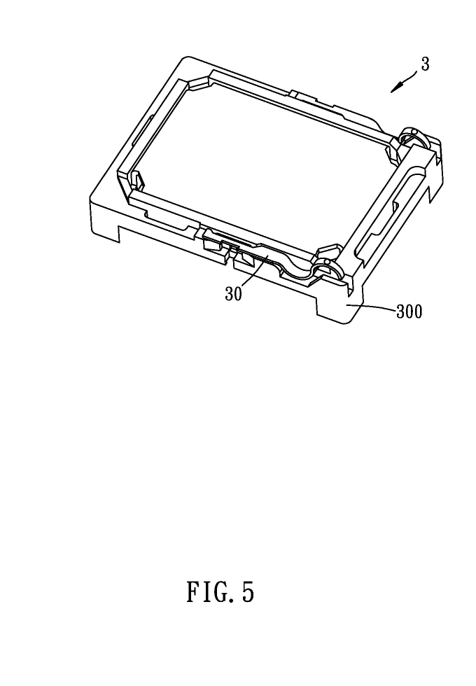

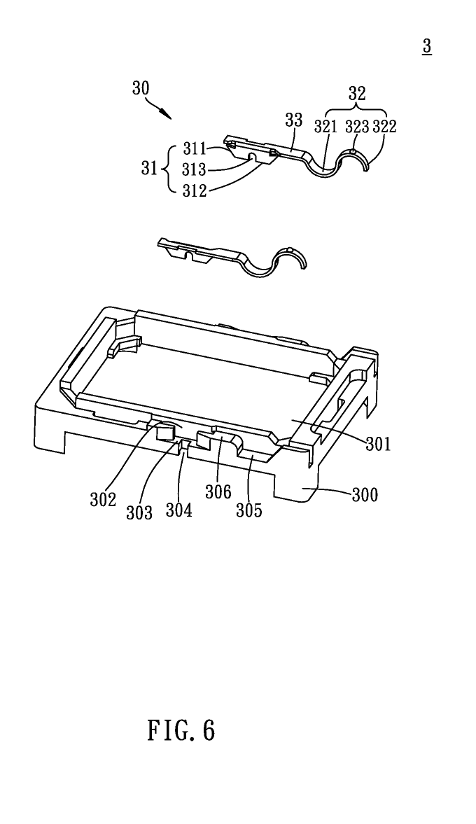

Please refer to FIG. 5 and FIG. 6, which is a three-dimensional view and an exploded view of an electrical connector according to a preferred embodiment of the invention. The electrical connector 3 has an insulating frame 300 and two terminals 30.

The insulating frame 300, which is hollowed to form an accommodation space 301 in the middle thereof for carrying a speaker, is made of an insulation material and has two inset grooves 302 formed respectively at the two opposite sides of the accommodation space 301 for allowing the two terminals 30 to inset therein. Each inset groove 302 is opened by a side thereof and is structured with a bottom surface 303, on which a wire channel 304 is formed to be used for enabling an electric unit to connect electrically to the terminal 30 therethrough. In addition, a recess 305 is formed at a position between each inset groove 302 and the end of the side where the inset groove 302 is disposed while the recess 305 is connected with its corresponding inset groove 302 by a bulge 306 while the top of such bulge 306 is flatted.

Each terminal 30 is made of an elastic conductive material and is composed of a fixing part 31, a movable part 32 and a connection part 33 that are integrally formed. The connection part 33 which is defined between the fixing part 31 and the movable part 32 is connected to a side of the fixing part 31 in a manner that it is parallel-extending along the longitudinal direction of the fixing part 31.

The fixing part 31 is disposed at an end of the connection part 33 while downward-extending from a side thereof, and being formed in a manner that two sides of the fixing part 31 are inclined as two inclined sides 311 to form respectively an obtuse angle between each of the inclined side 311 and the bottom 312 of the fixing part 31. As the result, the fixing part 31 is formed as a trapezoid with wider top and narrower bottom. In addition, the fixing part 31 is further configured with a gap 313 at the position between the two inclined sides 311 that is opened at the bottom 312, by which the terminal 30 can be compressed transversely for allowing the same to inset into its corresponding inset groove 302, and thereafter stretching by its elasticity for firmly fixing the fixing part 31 in the inset groove 302 to be connected electrically with a speaker without loosing. In an exemplary embodiment, the terminal 30 can be manufactured by stamp molding.

The movable part 32 of each terminal 30, which is disposed at the tip of the connection part 33 while extending along a longitudinal direction of the same, includes a first section 321 and a second section 322, in which the first section is connected to the tip of the connection part 33 in a manner that it is curved and thus concaved in relation to the connection part 33 while the second section 322 is connected to the tip of the first section 321 in a manner that it is curved and thus convex in relation to the connection part 33. Moreover, the second section 322 is formed with a top point on which a joint 323 is formed thereat. It is noted that when the fixing part 31 of the terminal 30 is inset into its corresponding inset groove 302, the first section 321 is received in the recess 305. As such, the first section 321 is positioned at a relevance level that is lower than that of the connection part 33 while the second section 322 is positioned at another relevance level that is higher than that of the connection part 33. Thereby, the movable part 32 is formed in an “S” shape.

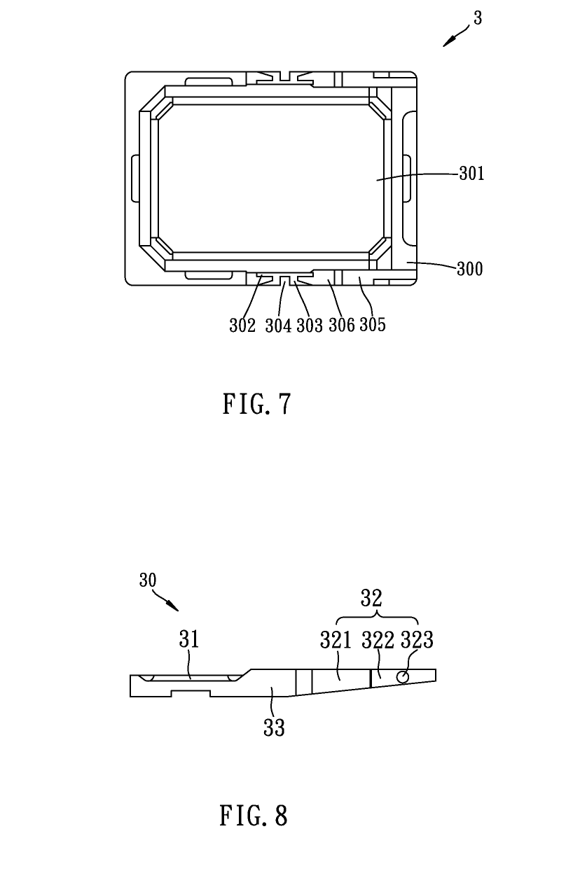

Please refer to FIG. 7, which is a top view of the insulating frame 300 used in the electrical connector 3 of the invention. In FIG. 7, the width of each inset groove 302 formed on the insulating frame 300 is obviously smaller than that of the recess 305 as well as that of the bulge 306.

Please refer to FIG. 8, which is a top view of the terminal 30 used in the electrical connector 3 of the invention. As shown in FIG. 8, the connection part 33 of the terminal 30 is shaped like a narrow bar at which the fixing part 31 is downward-extending from a side thereof while enabling the width of the fixing part 31 to be smaller than that of the connection part 33.

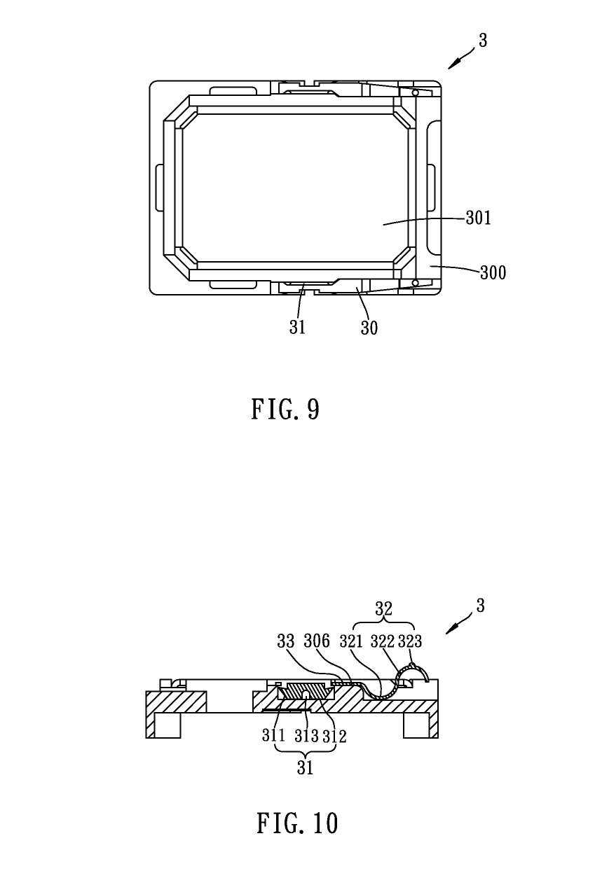

Please refer to FIG. 9 and FIG. 10 showing a top view and a cross-sectional view of the electrical connector 3 of the invention. In FIG. 9 and FIG. 10, as the terminal 30 is fixed on an insulating frame 300 in a manner that its fixing part 31 is vertical-extending disposed while its connection part 33 and movable part 32 are parallel-extending disposed and thus perpendicular to the fixing part 31, and also as the width of the fixing part 31 is smaller than that of the connection part 33 for enabling the cross-sectional area required for connecting the terminal 30 with the insulating frame 300 is smaller than the cross-sectional area of the connection part 33, the terminals 30 will occupy a relative smaller space available on the insulating frame 300 comparing with those conventional connectors so that the insulating frame 300 of the invention is able to carry speakers of larger volume since the space left for carrying the speaker on the insulating frame 300 is larger. Since the volume of the speaker is larger than the conventional electrical connector, the size of the magnet used in such speaker is also larger so that, in some way, the electrical performance of the speaker is improved.

As shown in FIG. 10, the fixing part 31 of the terminal 30 is fitted inside the inset groove 304 while disposing the connection part 33 at a position corresponding to the bulge 306 for receiving the first section 321 in the recess 305 and enabling the second section 322 to hang at a position near the corner of the insulating frame 300. In another word, the terminal is attached to the insulating frame 300 as a cantilever.

When the electrical connector 3 is connected to an electric device, by the elasticity of the flexible structure of the concave first section 321 and the convex second section 322 and the use of the fixing part 31 as support, the second section 322 will be pressed down and thus deformed to extend along the longitudinal direction of the connection part 33 while the force relating to such transverse deformation of the second section 322 is buffered by the concaved first section 321 so that the conventional disadvantage of elastic fatigue after the terminal 30 being subjected to the pressing force for a long time can be prevented, not to mention that as the force is buffered, the damage to the electric device caused by resulting reacting force can also be avoided. Thereby, the electrical connector 3 of the invention can connected fixedly to the electric device.

As each terminal 30 is fixed on a side of the insulating frame 300 at a position near the center thereof, the joint 323 formed on a top of the second section 322 is placed at a position near the corner of the insulating frame 300 which achieve a more reasonable structure comparing with those conventional electrical connectors.

To sum up, as cross-sectional area for connecting the terminal with its insulating frame is smaller than those conventional electrical connectors so that the terminals of the electrical connector of the invention will occupy a relative smaller space available on the insulating frame, the insulating frame of the invention is able to carry speaker of larger volume since the space left for carrying the speakers on the insulating frame is larger. Since the volume of the speaker is larger than the conventional electrical connector, the size of the magnet used in such speaker is also larger so that, in some way, the electrical performance of the speaker is improved.

Moreover, when the movable part of the terminal is pressed as the electrical connector is connected to an electric device, the second section 322 is pressed down and thus deformed to extend along a direction other than the pressing force while the force relating to such deformation of the second section 322 is buffered by the first section 321 so that the conventional disadvantage of elastic fatigue after the terminal 30 being subjected to the pressing force for a long time can be prevented, not to mention that as the force is buffered, the damage to the electric device caused by resulting reacting force can also be avoided.

Moreover, as the terminals used in the electrical connector of the invention is manufactured by stamp molding, no specific welding machinery or bending process is required so that no only the manufacturing cost of the present electrical connector is reduced, but also the complexity of the manufacturing process thereof is simplified.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electrical connector for electrically connecting with an electric-acoustic product, comprising:
an insulating frame, further comprising:
an accommodation space, formed at the middle of the insulating frame, for carrying a speaker; and
two inset grooves, respectively formed at two sides of the insulating frame;
and
two terminals, each being arranged for enabling one end thereof to be inset into its corresponding inset groove for preparing the end to electrically connect to the speaker while enabling another end thereof to be extended along the longitudinal direction of the inset groove for preparing the same to electrically connect with the electric-acoustic product;
wherein, as any of the two terminals is subject to a pressing force, the pressed terminal is deflected in relation to the insulating frame and thus extending in directions other than that of the pressing force.

2. The electrical connector of claim 1, wherein each of the two inset grooves is formed at the middle section of the corresponding side of the insulating frame.

3. The electrical connector of claim 1, wherein each inset groove is configured with a wire channel at the outer side of the bottom thereof for enabling an electric unit to electrically connect to the terminal and the speaker therethrough.

4. The electrical connector of claim 1, wherein the end of each terminal that is not inset into the inset groove is formed in an “S” shape for buffering the deformation of the terminal as it is subjected to the pressing force.

5. The electrical connector of claim 1, wherein the insulating frame is further configured with two recesses at the two sides thereof, for receiving the portion of its corresponding terminal that is ranged between its two ends.

6. The electrical connector of claim 1, wherein each terminal is inset elastically into the corresponding inset groove.

7. The electrical connector of claim 1, wherein each inset groove is formed along a longitudinal direction of the accommodation space.

8. A terminal, adapted to be fixed to an electrical connector for electrically connecting the same to an electric-acoustic product, comprising:
a connection part;
a fixing part, disposed at an end of the connection part while downward-extending from a side of the connection part, for being fixed securely on the electrical connector; and
an elastic movable part, disposed at another end of the connection part while extending along a longitudinal direction of the same;
wherein, as any of the two terminals is subject to a pressing force, the movable part is deform and thus extend along the longitudinal direction of the connection part.

9. The terminal of claim 8, being designed for enabling the same to be manufactured by a stamp molding process.

10. The terminal of claim 8, wherein the movable part further comprises:
a first section, connected to the tip of the connection part while extending along the longitudinal direction of the same;
a second section, connected to the tip of the first section while extending along the longitudinal direction of the connection part in a manner that the first section is able to buffer the deformation of the second section as it is pressed.

11. The terminal of claim 10, wherein the first section is positioned at a relevance level that is lower than that of the connection part while the second section is positioned at another relevance level that is higher than that of the connection part.

12. The terminal of claim 10, wherein the first section is connected to the tip of the connection part in a manner that it is curved and thus concaved in relation to the connection part while the second section is connected to the tip of the first section in a manner that it is curved and thus convex in relation to the connection part.

13. The terminal of claim 8, wherein the fixing part is configured with a gap for providing the same with a transverse elasticity.

14. The terminal of claim 8, wherein two sides of the fixing part are inclined to form respectively an obtuse angle between each of the inclined side and the bottom of the fixing part.
